(19) United States
(12) Patent Application Publication
(10) Pub. No.: US 2026/0187972 A1
(43) Pub. Date: Jul. 2, 2026

(54) METHODS AND SYSTEMS FOR USE IN COMPUTER VISION FOR SHADOW MITIGATION

(71) Applicant: VANTOR INC., Westminster, CO (US)

(72) Inventors: Michael ASCHENBECK, Wayzata, MN (US); Charles DANFORTH, Louisville, CO (US); Brett W. BADER, Lyons, CO (US)

(21) Appl. No.: 19/007,309

(22) Filed: Dec. 31, 2024

(51) Int. Cl. G06V 10/60; G06T 5/40

(52) U.S. Cl. CPC G06V 10/60; G06T 5/40; G06T 2207/20081

(57) ABSTRACT

Systems and methods for mitigating shadow segments from images are provided. One example computer-implemented method includes accessing an original image of a geospatial location including a first shadow segment and generating, using a model architecture, a matte for the original image. The method also includes generating a first histogram of tones of shadow pixels of the first shadow segment in the original image, generating a second histogram of tones of an adjacent region of the original image, which is proximate to the first shadow segment yet outside a boundary of the first shadow segment, defining a lookup table based on histogram matching between the first histogram and the second histogram, and relighting the original image based on the lookup table.

### FIELD

The present disclosure generally relates to methods and systems for use in computer vision for shadow mitigation from images, and in particular, for use in computer vision to mitigate shadow segments in images, using image data from the shadows, while accounting for variable translucence of objects casting/causing the shadow segments.

### BACKGROUND

This section provides background information related to the present disclosure which is not necessarily prior art.

Geospatial images are known to be captured by various capture devices, such as, for example, satellites, manned aerial vehicles, or micro air/aerial vehicles (MAVs), unmanned aerial vehicles (UAVs), etc. Depending on relative locations of the capture devices, impediments may be present in the images, which limit the content, or completeness, of the images. One or more clouds, for example, may exist between a capture device and a geospatial location, which blocks out at least a portion of the capture device's view of the geospatial location. Consequently, the image of the geospatial location is incomplete. Beyond the cloud(s) itself/themselves blocking part of the geospatial location, the cloud(s) may also introduce shadows into the images, which still permit imaging of the geospatial location (in the shadows), but with variant intensities as compared to un-shadowed locations.

It is known to perform cloud “punching” on the images to remove the clouds, whereby a cloud included in an image is replaced from donor image of the same geospatial location which does not include the cloud. The shadows associated with the clouds may also be removed in a similar manner, by replacing the shadows with segments of donor images of the geospatial locations which do not include the shadows. Another example shadow removal technique is described in: “Physics-based shadow image decomposition for shadow removal,” by Hieu Lea and Dimitris Samaras, IEEE Transactions on Pattern Analysis and Machine Intelligence, Vol. 44, Chapter 12, (2022).

### SUMMARY

This section provides a general summary of the disclosure and is not a comprehensive disclosure of its full scope or all of its features.

Example embodiments of the present disclosure generally relate to methods (e.g., computer-implemented methods, etc.) for use in mitigating shadow segments from images. In one example embodiment, such a method generally includes: accessing, by a computing device, an original image of a geospatial location, the original image including a shadow segment; generating, by the computing device, using a model architecture, a matte for the original image, based on the image and a shadow mask for the image, the model architecture including a U-Net model; (a) generating, by the computing device, a first histogram of tones of shadow pixels of said shadow segment included in the original image; (b) generating, by the computing device, a second histogram of tones of an adjacent region of the original image, which is proximate to the first shadow segment, yet outside a boundary of the shadow segment; (c) defining, by the computing device, a lookup table based on histogram matching between the first histogram and the second histogram; (d) relighting, by the computing device, the original image based on the lookup table; (e) based on the shadow mask and the matte, generating a shadow-mitigated image from the relighted image of the original image, whereby the shadow segment in the original image is mitigated; and storing the shadow-mitigated image in a memory.

Example embodiments of the present disclosure also relate to non-transitory computer-readable storage media including executable instructions for processing image data (e.g., mitigating shadow segments from images, etc.). In one example embodiment, such a non-transitory computer-readable storage medium includes executable instructions, which when executed by at least one processor, cause the at least one processor to perform the operations of the method described above.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for mitigating shadow segments from images (e.g., aerial images, etc.) of geospatial locations, for example, caused by objects such as clouds;

FIGS. 2A-2B include example images that may be utilized (e.g., processed, etc.) in connection with the system of FIG. 1;

FIG. 3 is a block diagram of an example model architecture that may be used in the system of FIG. 1;

FIG. 4 is a block diagram of an example computing device that may be used in the system of FIG. 1;

FIG. 5 illustrates an example method, which may be used in (or implemented in) the system of FIG. 1, for use in mitigating shadow segments from images; and

FIGS. 6A-6C illustrate processing of an example aerial image (FIG. 6A) having a shadow segment through the method of FIG. 3, in which the example aerial image is relighted (FIG. 6B) and the shadow segment is mitigated (FIG. 6C).

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In connection with aerial images, from time to time, objects cause the appearance of shadows in the images. The objects may include, for example, clouds, whereby depending on the translucence of the clouds, which generally varies throughout, sunlight is permitted to reach the ground. Consequently, brightness of the ground, within the shadows, varies consistent with the translucency of the clouds and the sun's penetration of the clouds. This variation creates difficulty in relighting the shadows in images, as lighting shadows with a fixed gain/bias provides limited accuracy due to such variations. With regard to the example mitigation techniques (by Hieu Lea and Dimitris Samaras), noted above, for example, it is difficult, if not impossible, to obtain pairs of images with both shadows present and no shadows present. Available solutions therefore, unfortunately, in practice, lead to poor inference performance in mitigating real cloud shadows.

Uniquely, the systems and methods herein provide a unique process of accurately relighting shadows (or shadow segments) within images, to thereby mitigate the shadow segments from the images.

In particular, the present disclosure describes the mitigation of shadow segments (e.g., removal of shadows, brightening of shadows, etc.) from an image by leveraging the image data included in the shadow segments (rather than replacing the shadow segments with other image data). To do so, a specific model architecture is trained to generate a matte for the image, where the training is based on a set of training images-and-masks. Each training sample consists of a shadow-free image, a corresponding synthetic shadow-added image, the shadow mask used to generate the synthetic shadow segments, the corresponding shadow parameters (e.g., from another suitable model (e.g., SP model, etc.), or as defined, etc.), and potentially one or more normalized differences, etc. The trained matte model then generates a matte for an original image. The matte is used in combination with a relighted image, based on histogram matching of a shadow segment to an un-shadowed region of the image, to create a shadow-mitigated image from the original image.

In this way, the systems and methods herein leverage the data included in the shadow segments to aid in automatic relighting of the shadow segments, thereby providing an improved (and more accurate) representation of the shadowed region(s). This defines a technical improvement and transformation of the original images, which defines unconventional rules to relight a shadow segment in the image, rather than replacing the shadow segments from other images, and which specifically accounts for the variation of the translucency of the clouds or other objects casting the shadow segment(s), through the per-shadow histogram, to define the relighting, along with (or in combination with) the matte.

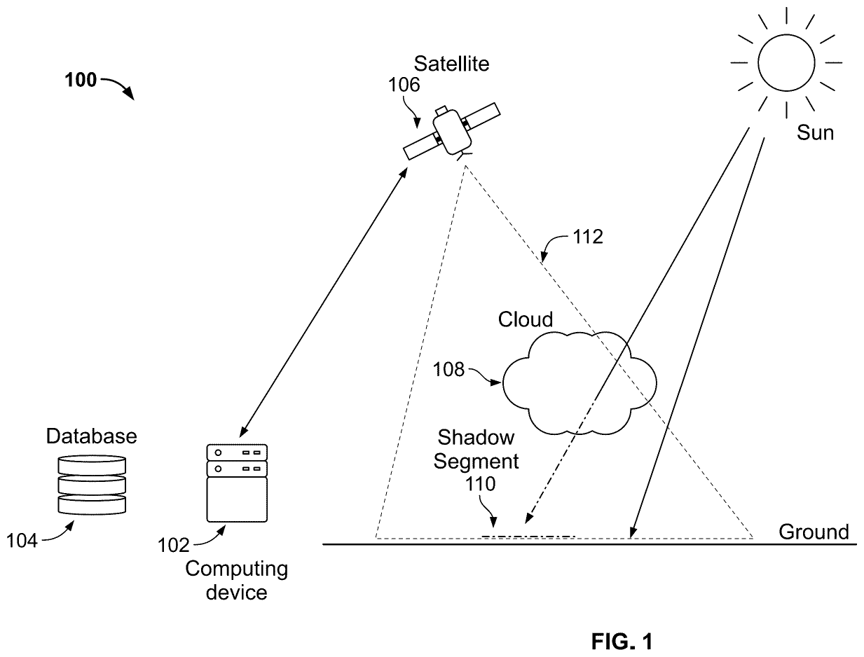

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, sources and/or types of image data, capture devices used to capture images of geospatial locations, privacy rules and/or regulations, etc.

In the example embodiment of FIG. 1, the system 100 generally includes a computing device 102 and a database 104, which is coupled to (and/or is otherwise in communication with) the computing device 102, as indicated by the arrowed line. The computing device 102 is illustrated as separate from the database 104 in FIG. 1, but it should be appreciated that the database 104 may be included, in whole or in part, in the computing device 102 in other system embodiments.

In addition, the system 100 also includes (and/or is in communication with) satellite 106, which is representative of multiple different satellites orbiting the Earth and configured to capture various images of the surface of the Earth. One example satellite system, which may include the satellite 106, includes the MAXAR constellation of satellites (e.g., QuickBird or WorldView-series satellite constellation, etc.), or other constellation of satellites, such as, for example, the Landsat satellite constellation, the Sentinel-2 satellite constellation, etc. The satellite system(s)/constellation(s) may be configured to capture images of the ground at different resolutions, at one or more different intervals.

In this example embodiment, satellite 106 is configured to capture one or more images of the ground, at an interval of once per N days, for example, where N may include one day (i.e., daily), two days, five days, seven days (i.e., weekly), ten days, or other number of days therebetween, or other number of days more than ten days, etc. Also, the images may include different geographic resolutions, depending on the particular satellite 106 employed in capturing the images. In one example, the images may include a resolution of about 10 meters by 10 meters per pixel, while in another example, the images may include a resolution of about three meters by three meters, etc. In still other examples, the resolution may be higher, or lower, again, depending on the satellite 106 (or other apparatus) employed in capturing the images.

After the image(s) are captured, the satellite 106 is configured to transmit the images, directly or indirectly, to the database 104, which is located on Earth (or on the ground). The images may be transmitted, as each is captured, or the images may be transmitted at one or more intervals, singularly or in batches, etc. The images are then stored in the database 104 and made available to the computing device 102.

In this example embodiment, the satellite 106 is configured to capture hundreds or thousands of images, during various intervals. As such, for the satellite 106, which again may be representative of multiple satellites, the database 104 includes thousands, hundreds of thousands, millions, tens of millions, etc., images of various locations across the Earth.

While satellite 106 is included in the system 100, it should be appreciated that other image capture devices may be used in other system embodiments, including, for example, unmanned aerial vehicles (UAVs) (e.g., inside the atmosphere) (e.g., drones, etc.), manned aerial vehicles, or micro air/aerial vehicles (MAVs), or other devices sufficiently positioned to capture images of various geospatial locations singularly, or repeatedly over various intervals. In several examples, the images include a top-down view, which includes a perspective view or a plan view of the ground, generally captured from above or “overhead” relative to the ground location.

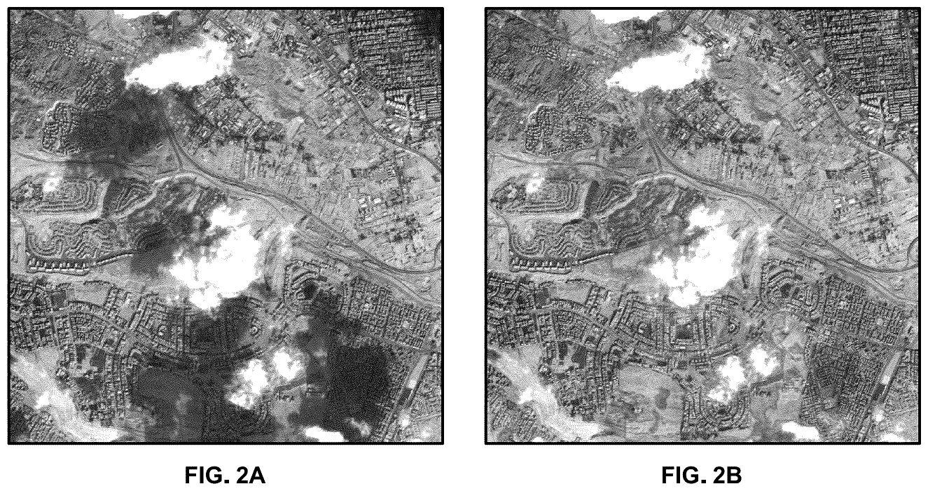

In connection with the above, the satellite 106 may include a clear view of the ground, whereby the images captured by the satellite 106 are unobstructed to the ground. Additionally, or alternatively, as shown in FIG. 1, one or more clouds, such as, for example, the cloud 108, may be positioned between the sun and the ground, whereby a shadow or shadow segment 110 (which may include one or more shadow) is created on the ground. The shadow segment 110 may further be included in the view 112 of the satellite 106, as indicated by the dotted shape. When the shadow segment 110 is within the view 112, the captured image of the ground includes the shadow segment 110, and potentially, also the cloud 108. Examples of ground images, which include both clouds and shadows, are illustrated in FIG. 2A. As shown, the ground is in fact visible in the shadow regions but darker or less bright than the non-shadow regions of the images. The brightness of the shadow regions then is reduced based, in part, on the translucency of the clouds, i.e., how much sunlight is permitted to pass therethrough. The translucency may be consistent, or not, depending on how, or if, densities of the clouds vary throughout.

It should be understood that due to the shadows (or shadow segments) in images, it may be problematic to construct the images into uniform mosaics of multiple images, for example, or more generally, to provide a clear view of the ground through the images. In connection with the above, the computing device 102 is configured to mitigate the shadow segments, by relighting or brightening the shadowed regions of the images (consistent with the surrounding image(s)), as if the cloud(s) was/were not present in the sky when the image(s) was/were captured.

Initially, as it relates to the shadow segments, the computing device 102 is configured to access a training set of images. The images may be compiled specifically to include, for example, a diverse set of biomes and land use areas (e.g., urban, rural, mountain, etc.) in order for the trained model to be robust to the images to be later input to the model. The training set of images includes only images that do not include clouds and/or shadows (or shadow segments).

In this example embodiment, the computing device 102 is configured to then generate synthetic shadow segments in the images of the training set, to thereby provide shadow images corresponding to each of the shadow-free images, or more specially, synthetic shadow-added images. To do so, for an example, the computing device 102 is configured to utilize (e.g., input, etc.) a shadow-free image in the set of shadow-free images, and a binary shadow mask for one or more realistic cloud shadow shapes, based on historical cloud shapes. A shadow matte is created, by the computing device 102, for example, by copying the shadow mask and allowing fractional values. In connection therewith, the computing device 102 is configured to fractalize edges of the shadow matte, to more accurately emulate a cloud shadow (or shadow segment). Next, the computing device 102 is configured to add one or more Perlin noise transparency layers (or other gradient noise layer, etc.) to the shadow matte to define brightness variations in the shadow matte. Also, the computing device 102 may be configured to apply Gaussian smoothing to the edges of the shadow matte to provide for more realistic penumbra. The result, in this example, is a realistic shadow matte. The computing device 102 is configured to reduce the brightness of a part of the shadow-free image by a band-dependent gain and/or bias, consistent with the shadow matte, to provide the synthetic shadow segment in the image. It should be appreciated, then, that the gain and bias of the shadow segment (relative to the original image) is defined by the computing device 102, in generating the synthetic shadow-added images. It should be understood that the shadow mask (i.e., for the synthetic shadow segments) should be stored and may further be used as an input, as explained below, along with the synthetic shadow-added image. The shadow matte may be stored, for example, for use in supervision of M-Net outputs.

The computing device 102 is configured to generate synthetic shadow segments, where each image includes one or more shadow segments, for each of the images in the training set. As such, each shadow-free image is associated with a synthetic shadow-added image.

The shadow mask is, generally, a binary map of the image, with masked areas denoting shadow pixels and unmasked areas denoting un-shadowed pixels. As noted above, the mask may include one or more realistic cloud shadow shapes, based on historical cloud shapes. The shadow mask for each image forms part of the training set.

Next, the computing device 102 is configured to calculate one or more spectral indices for the images. That is, the native or original images include color data for Red, Green, and Blue, and also data for near-field infrared (NIR) and possibly other visible and near-infrared (VNIR) and short-wave infrared (SWIR). Additionally, then, for example, the computing device 102 is configured to calculate a normalized difference vegetative index, per pixel, as NDVI=(NIR−Red)/(NIR+Red) for each of the images in the training set. It should be understood that additional indexes may also be calculated, such as, for example, without limitation, the normalized difference glacier index (NDGI) or (NIR-Green)/(NIR+Green), normalized difference aquatic vegetation index (NDAVI) or (NIR-Blue)/(NIR+Blue), normalized difference moisture index (NDMI) or (NIR−SWIR)/(NIR+SWIR), advanced vegetation index (AVI) or [NIR*(1−Red)*(NIR−Red)]^{1/3}, bare soil index (BSI), etc., or any other suitable spectral index, etc. It should be appreciated that the computing device 102 may be configured to calculate still further indexes as desired or appropriate.

Thereafter, the computing device 102 is configured to append, or otherwise associate, the index values to the pixels of the images in the training set. Consequently, for each image in the training set, the data for each pixel includes, without limitation, values for Red, Green, Blue, NIR, NDVI, NDAVI, etc., for example, in the database 104.

In addition to the above, it should be appreciated that one or more other processes may be applied to the images to enhance the data therein, or to correct the data therein to provide for accuracy and/or capability with subsequent operations herein.

It should also be appreciated that the training set of images may include thousands of images, or tens of hundreds or thousands of images, etc., where each image is associated with a shadow image, a shadow mask, and the index values (e.g., pixel-level index values, etc.), etc.

In this example embodiment, then, in connection with processing an image having a shadow segment, the computing device 102 is configured to generate a shadow-mitigated image (from the input image), based on the below expression represented as Equation (1):

$${I}^{shadow} * ( 1 - α ) + {I}^{relit} * α = {I}^{shadow - mitigated} \qquad ( 1 )$$

where I^{shadow} is the original image, a is the matte (which essentially is a fractional mask (e.g., each pixel has a fractional value between 0 and 1, etc.)), and I^{relit} is the relighted image. The relighted image is then expressed as Equation (2):

$${I}^{relit} = w * {I}^{shadow} + b \qquad ( 2 )$$

where w is the gain vector, and b is the bias vector.

It should be appreciated that generating the shadow-mitigated image (from the input image) may be performed per shadow segment in the input image (or shadow mask). As such, where the shadow mask indicates that the input image includes multiple shadow segments (e.g., several shadows, etc.), the generating is performed as described herein separately for each of the shadow segments.

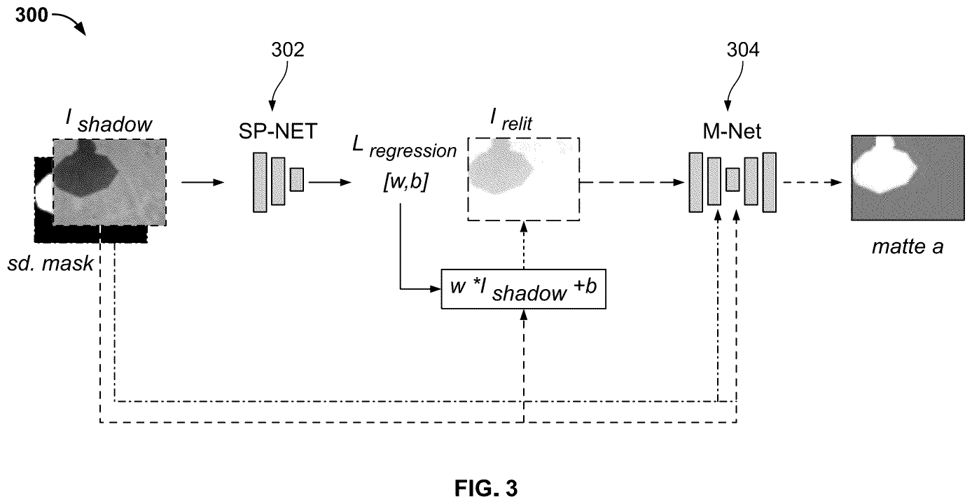

In the above, the unknowns to determine the shadow-mitigated image are the gain, w, the bias, b, and the matte, a. The computing device 102 is configured to leverage the training set to train a deep learning model to determine the same. In particular, in this example embodiment, the computing device 102 is configured to train, with the training set, a deep learning model architecture 300, which is illustrated in FIG. 3. As shown, the model architecture 300 includes a first model 302 based on a shadow parameter estimator network or SP-NET model (e.g., where the shadow parameters are gain (w), bias (b), etc.) and a second model 304 based on a shadow matte prediction network or M-Net model (e.g., where the matte is again a, etc.). In this particular embodiment, the SP-net model is implemented as a ResNeXt regressor model, and the M-Net model is implemented with a U-Net architecture. That said, in various embodiments, the SP-Net may be implemented as another suitable neural network model, including, without limitation, a VGGNet, ResNet, MobileNet, Inception, and Vision Transformer (ViT) models, etc. Similarly, in various embodiments, the M-Net may be implemented as another suitable neural network architecture, which includes an encoder-decoder structure with optional skip connections and/or other configurations that support efficient feature extraction and reconstruction, etc.

Each shadow image and shadow mask from the training set is input to the model architecture 300, with the shadow-free image from the training set being the target image. SP-net and M-net models are trained specifically for implementation herein. Initially, model weights are randomly initialized. A stochastic gradient descent (SGD) algorithm is then employed to iteratively update the model parameters. In doing so, a batch of samples is randomly selected from the training set, and the inputs are passed through the model in FIG. 3, followed by computing Equation (2), followed by computing the shadow-mitigated image, I^{shadow-mitigated}, in Equation (1). The loss is defined as the mean absolute error (MAE) between the shadow-free target image and each corresponding shadow-mitigated prediction. Gradients are then calculated via backpropagation.

It should be appreciated that, alternatively, the network may be supervised by the shadow matte. That is, the loss may be defined as the sum of the mean absolute error (MAE) between the shadow-free target image and each corresponding shadow-mitigated prediction and a weighted MAE of the shadow matte and each corresponding M-Net output.

It should also be appreciated that, alternatively, the gain and bias from the synthetic shadow segment generation may be used in place of the SP-net model. That is, the computing device 102 may be configured to access the gain and bias, which were used to generate the synthetic shadow segments in the images in the training set, and to use the accessed gain and bias, per image to be analyzed, as an input to the U-net model. In this manner, the SP-net model, or first model 302, may be omitted from the model architecture 300.

Once trained, the SP-Net model (or first model 302) configures the computing device 102 to determine gain and bias from a shadow image and a shadow mask, and the M-Net model (or second model 304) configures the computing device 102 to determine a matte from the relighted image, the shadow image, the shadow mask, and the index values. The trained model architecture 300 is then stored in memory for use as described below. It should be appreciated that the deep learning model architecture 300 may be retrained at one or more intervals, based on the same, different or additional training data. It should be further appreciated that various different deep learning models, or otherwise, may be employed in place of the example ResNeXt regressor model and the example U-Net architecture noted above, whereby the model architecture 300 is not limited thereto.

Thereafter, in this example embodiment, the computing device 102 is configured, using the trained model, to generate a shadow-mitigated image, or inference, from an original shadow image captured by the satellite 106, such as, for example, the shadow image of FIG. 2A. In doing so, the computing device 102 is configured to calculate the shadow-mitigated image using Equation (1).

Specifically, the computing device 102 is configured to define a shadow mask for each of the images included in an inference set, and each shadow segment included therein. The computing device 102 may be configured to generate the shadow mask for each image in the inference set, using techniques such as thresholding or residual U-Nets. Additionally, the techniques included in bipartite cloud matching can be used to increase the quality of the shadow masks (U.S. application Ser. No. 18/792,281, filed Aug. 1, 2024), which is incorporated herein by reference.

Also, in this example embodiment, the computing device 102 is configured to calculate one or more indexes for the shadow image. Generally, the index(es) calculated will be the same as the index(es) used in training the second model 304, i.e., the U-net model, in the above training phase for the deep learning model architecture 300. As such, the computing device 102 is configured, for example, to calculate NDVI and NDAVI, etc., for the shadow image, and to append, or otherwise associate, the values to the pixels of the shadow image (e.g., including the index(es) in the shadow image data, etc.).

Next, the computing device 102 is configured to generate the matte, using the trained deep learning model architecture 300. In doing so, the computing device 102 is configured to input the shadow image into the SP-Net model, along with the shadow mask for the image, whereby the computing device 102 is configured, by the trained SP-Net model, to generate gain (w) and bias (b) for the image. The computing device 102 is then configured to input the gain and bias, along with the shadowed image (and the index values) and the shadow mask, to the M-Net model, whereby the computing device 102 is configured, by the trained M-Net model, to generate the matte for the shadow image, which is denoted as a.

Further, the computing device 102 is configured to identify the shadow segment(s) in the shadow image, based on the shadow mask. In one or more examples, the computing device 102 is configured to identify the shadow segments based on the shadow mask and a technique for identifying connected components. In connection therewith, the computing device 102 is configured to traverse the shadow mask to identify a shadow pixel (i.e., a pixel indicated in the mask as part of a shadow segment), whereby each connected shadow pixel is identified to that shadow segment before continuing to traverse the shadow mask for a next shadow pixel (unconnected to the prior shadow segment). When the traversal is completed, all shadow segment(s), if any, are identified.

Next, the computing device 102 is configured to generate the relighted image for the original image, consistent with Equation (2). In this example embodiment, the computing device 102 determines the gain and bias separately for each shadow segment identified as described above in the shadow mask. In particular, in this example embodiment, the relighted image for each shadow segment is calculated based on a histogram matched lookup table (LUT), specific to the shadow segment being mitigated. That is, the computing device 102 is configured to generate a histogram for the shadow segment and to also generate a histogram for a region adjacent to the shadow segment in the shadow image. The adjacent region may include a band of p-pixels around the outside boundary of the shadow segment, directly or adjacent or spaced by m-pixels from a boundary of the shadow segment, where p is between one and 100 pixels, between 10 and fifty pixels, or other suitable number; and where m is 1, 3, 7, 10, 25, etc. Any pixels marked as shadow segments in the shadow mask are then excluded from this adjacent region. Additionally, if a mask of cloud pixels is available, any pixels marked as cloud in the cloud mask are then excluded from this adjacent region. The histograms are generated based on ranges of tone values, where each pixel is added to the histogram, and the histogram is defined as a number of pixels within the specific range of tones for each range.

The computing device 102 is configured to then perform histogram matching, between the histogram of the shadow region and the histogram of the adjacent region, to define to the transformation necessary to illuminate or relight the shadow region. The matching defines the lookup table (LUT), whereby, for each tone in the shadow region, there is a corresponding brightened tone. The computing device 102 is then configured to generate the relighted image, I^{relit}, by applying the LUT to the entire original image.

With the relighted image and the matte, as explained above, the computing device 102 is configured, consistent with Equation (1), to multiply the shadow image by one minus the matte, or I^{shadow}*(1−a) and to multiple the relighted image by the matte, i.e., I^{relit}*a, and finally, to sum the results to provide the original image with the shadow mitigated, i.e., a shadow-free image. Also, in connection therewith, the computing device 102 is configured to assign a value of zero in the matte, «, for all pixels outside the specific shadow segment being relighted.

For the original or input image, the computing device 102 is configured to then repeat the above for each shadow segment identified from the shadow mask, where there is more than one identified shadow segment.

When each of the shadow segments is mitigated, the computing device 102 is configured to store the shadow-mitigated image in the database 104.

It should be appreciated that, based on the above, the shadow mask and shadow matte above are generally computed once for the image, while the relighting steps are repeated for each of the multiple shadow segments included in the shadow mask (or input image), if applicable, individually.

With reference to the shadow image of FIG. 2A, the shadow-mitigated image of FIG. 2B is the resulting image from implementation, through the computing device 102, of the operations described above. As such, the shadow region is illuminated consistent with the un-shadowed terrain of the original image.

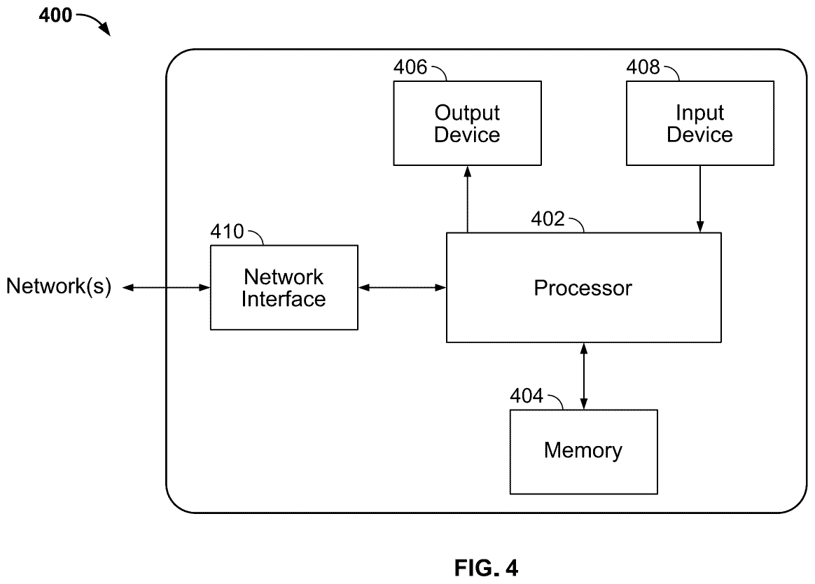

FIG. 4 illustrates an example computing device 400 that may be used in the system 100 of FIG. 1. The computing device 400 may include, for example, one or more servers, workstations, personal computers, laptops, tablets, smartphones, virtual devices, etc. In addition, the computing device 400 may include a single computing device, or it may include multiple computing devices located in close proximity or distributed over a geographic region, so long as the computing devices are specifically configured to operate as described herein. What's more, it should further be appreciated that the computing device may be configured consistent with one or more cloud, fog, and/or mist computing architectures.

In the example embodiment of FIG. 1, the computing device 102, the database 104, and the satellite 106 may include and/or be implemented in one or more computing devices consistent with computing device 400. The database 104 may also be understood to include and/or be implemented in one or more computing devices, at least partially consistent with the computing device 400. However, the system 100 should not be considered to be limited to the computing device 400, as described below, as different computing devices and/or arrangements of computing devices may be used. In addition, different components and/or arrangements of components may be used in other computing devices.

As shown in FIG. 4, the example computing device 400 includes a processor 402 and a memory 404 coupled to (and in communication with) the processor 402. The processor 402 may include one or more processing units (e.g., in a multi-core configuration, etc.). For example, the processor 402 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 404, as described herein, is one or more devices that permit data, instructions, etc., to be stored therein and retrieved therefrom. In connection therewith, the memory 404 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 404 is configured to store data including, without limitation, images, masks, mattes, models (e.g., trained, untrained, etc.), shadow parameters, histograms, and/or other types of data (and/or data structures) suitable for use as described herein.

Furthermore, in various embodiments, computer-executable instructions may be stored in the memory 404 for execution by the processor 402 to cause the processor 402 to perform one or more of the operations described herein (e.g., one or more of the operations of method 500, etc.) in connection with the various different parts of the system 100, such that the memory 404 is a physical, tangible, and non-transitory computer readable storage media. Such instructions often improve the efficiencies and/or performance of the processor 402 that is performing one or more of the various operations herein, whereby such performance may transform the computing device 400 into a special-purpose computing device. It should be appreciated that the memory 404 may include a variety of different memories, each implemented in connection with one or more of the functions or processes described herein.

In the example embodiment, the computing device 400 also includes an output device 406 that is coupled to (and is in communication with) the processor 402 (e.g., a presentation unit, etc.). The output device 406 may output information (e.g., shadow-mitigated images, etc.), visually or otherwise, to a user of the computing device 400. It should be further appreciated that various interfaces (e.g., as defined by network-based applications, websites, etc.) may be displayed or otherwise output at computing device 400, and in particular, at output device 406, to display, present, etc., certain information to the user. The output device 406 may include, without limitation, a liquid crystal display (LCD), a light-emitting diode (LED) display, an organic LED (OLED) display, an “electronic ink” display, speakers, a printer, etc. In some embodiments, the output device 406 may include multiple devices. Additionally, or alternatively, the output device 406 may include printing capability, enabling the computing device 400 to print text, images, and the like, on paper and/or other similar media.

In addition, the computing device 400 includes an input device 408 that receives inputs from the user (i.e., user inputs) such as, for example, selections of images, locations, desired characteristics, etc. The input device 408 may include a single input device or multiple input devices. The input device 408 is coupled to (and is in communication with) the processor 402 and may include, for example, one or more of a keyboard, a pointing device, a touch sensitive panel, or other suitable user input devices. It should be appreciated that in at least one embodiment the input device 408 may be integrated and/or included with the output device 406 (e.g., a touchscreen display, etc.).

Further, the illustrated computing device 400 also includes a network interface 410 coupled to (and in communication with) the processor 402 and the memory 404. The network interface 410 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network, etc.), including the network or other suitable network capable of supporting wired and/or wireless communication between the computing device 400 and other computing devices, including with other computing devices used as described herein (e.g., between the computing device 102, the database 104, etc.).

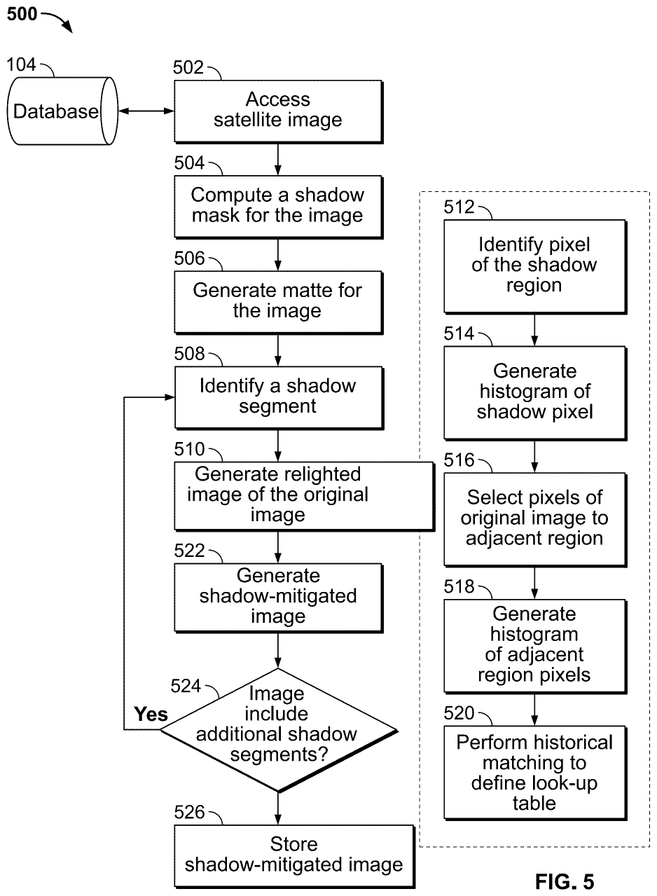

FIG. 5 illustrates an example method 500 for mitigating shadow segments from images. The example method 500 is described herein in connection with the system 100, and may be implemented, in whole or in part, in the computing device 102 of the system 100 and the deep learning model architecture 300 of FIG. 3. Further, for purposes of illustration, the example method 400 is also described with reference to the computing device 400 of FIG. 4. However, it should be appreciated that the method 500, or other methods described herein, are not limited to the system 100 or the model architecture 300 or the computing device 400. And, conversely, the systems, models, and the computing devices described herein are not limited to the example method 500.

At the outset, it should be appreciated that the database 104 includes a training set, which includes hundreds, thousands, etc., shadow-free images, along with shadow masks for the images and corresponding shadow images, which include synthetic shadow segments, i.e., synthetic shadow-added images. In addition, the database 104 also includes one or more original shadow images, captured by the satellite 106, whereby the shadow segments are real and thus not synthetic.

In addition, the deep learning model architecture 300 is trained, as explained above, to generate a matte, based on an input shadow image and a corresponding shadow mask.

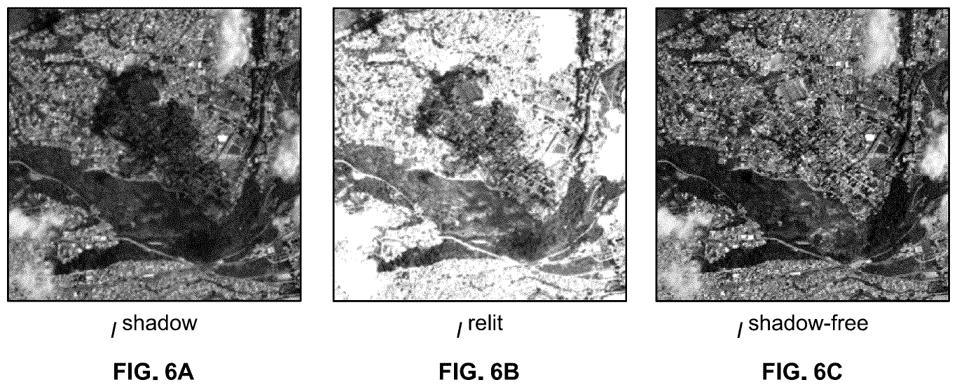

At 502, the computing device 102 accesses an original image of the ground, from the database 104. An example original image is illustrated in FIG. 6A. As shown, the image (e.g., captured by the satellite 106, etc.) includes one or more clouds, or at least part of the cloud, and a shadow segment based on the presence of the cloud(s) between the sun and the ground included in the image.

In order to mitigate the shadow segment from the image, or to illuminate the shadow segment, the computing device 102 first computes, at 504, a binary shadow mask for the image. Various techniques may be employed to compute the shadow mask. One such technique may include thresholding a normalized difference index. Another technique may be to train a residual U-Net. Further, various techniques may be employed to increase the quality of the shadow mask, including, for example, cloud-shadow bipartite matching, etc. Each connected set of shadow pixels in the shadow mask is henceforth referred to as a shadow segment.

At 506, the computing device 102 generates a matte for the original image. That is, the original image (e.g., original shadow image, etc.) and the shadow mask are input to the trained deep learning model architecture 300, and in particular, the first model 302 thereof. The shadow parameters are determined, based on the inputs, by the computing device 102, for the shadow segment(s) in the original image, i.e., gain and bias. The computing device 102 then provides the shadow parameters, the original image, the shadow mask and index values, as applicable, to the second model 304 of the model architecture 300. In turn, using the model architecture 300, the computing device 102 generates a matte for the original image.

It should be appreciated that in one or more embodiments, in which the first model 302 is omitted, the computing device 102 may rely on the shadow parameters, as defined below through the histogram matching lookup table for the specific image, as an input to the second model 304.

The shadow mask may contain zero, one, or more shadows. The computing device 102 identifies the shadow segment(s) in the image, at 508, based on the shadow mask. The shadow segment(s) includes, generally, each contiguous or connected shadow(s) in the shadow mask (e.g., where two or three overlapping, connected shadows are considered a single shadow segment, etc.). The identification of the shadow segments from the shadow mask may be based on, for example, connected component labeling, as explained above.

Consequently, for each shadow segment identified in the shadow mask, the computing device 102 generates a relighted image for the shadow segment, at 510. In particular, in this example embodiment, initially, the generating of the relighted image includes determining, by the computing device 102, the lookup table (LUT) for the shadow segment. To do so, as illustrated in the dotted box in FIG. 5 as part of step 510, in this example embodiment, the computing device 102 identifies, at 512, the pixels of the shadow segment, i.e., the shadow region based on the shadow mask.

Next, the computing device 102 generates, at 514, a histogram of the shadow segment, whereby, for each pixel, a count specific to a tonal range is incremented. That is, the histogram is a representation of the tonal distribution of pixels in the shadow segment, where the tonal distribution is segregated into tonal ranges and the count for that range is incremented for each pixel in the range (e.g., frequency, etc.).

At 516, the computing device 102 selects an adjacent region of pixels from within the image, where the pixels are adjacent to a boundary of the shadow region. The adjacent region may include hundreds or more pixels, which are within a defined distance of the shadow segment (e.g., within a number of pixels, etc.). The adjacent region is generally defined to avoid clouds and other shadow segments in the original image and/or to represent the general tonal distribution of the original image, etc. At 518, the computing device 102 generates a histogram of the adjacent region, whereby, for each pixel therein, a count specific to a tonal range of the tonal distribution is incremental.

The computing device 102 then performs, at 520, histogram matching between the histogram for the shadow segment and the histogram for the adjacent region to define a lookup table or LUT, which may be used to illuminate the shadow segment to be consistent, tonally, with the adjacent region. For example, in Table 1, the LUT may be used to lighten darker tones. In this example the plausible intensity ranges are 0-10. The original intensity 1 is lightened to 2; the original intensity 2 is lightened to 4, and the original intensities 4 and higher have reached the intensity maximum and are all lightened to 10. Notwithstanding the above, it should be appreciated that other example LUTs may be employed in other embodiments, which defines other lightening intensities for original intensities, etc.

TABLE 1

| Original Intensity | Lightened Intensity |
|---|---|
| 0 | 0 |
| 1 | 2 |
| 2 | 4 |
| 3 | 8 |
| 4 | 10 |
| 5 | 10 |
| 6 | 10 |
| 7 | 10 |
| 8 | 10 |
| 9 | 10 |
| 10 | 10 |

In this example embodiment, the computing device 102 generates the relighted image, by application of the lookup table to the original image. The relighted image is illustrated in FIG. 6B. As shown, the illumination of the relighted image is not limited to the shadow segment, as each pixel in the image, in this embodiment, is illuminated consistent with the lookup table. However, the matte may be limited to the region containing the specific shadow segment being mitigated, whereby it should be understood that pixels outside of the current shadow segment being relit remain unchanged.

Referring again to FIG. 5, as it relates to Equation (1), the computing device 102 then calculates, at 522, the shadow-mitigated image as an inference, based on the shadow image, the relighted image and the matte, from the deep learning model architecture 300. The shadow-mitigated image is illustrated in FIG. 6C. As shown, the shadow region is illuminated consistent with the remainder of the original image, effectively mitigating the shadow segment from the image.

Next, as shown in FIG. 5, the computing device 102 may determine, at 524, if the image includes one or more additional shadow segments. If so, the computing device 102 repeats steps 508, 510, and 522, as described above, for each of the shadow segments. When the image does not include another shadow segment, the computing device 102 stores, at 524, the shadow-mitigated image in the database 104, and potentially, to display the shadow-mitigated image to one or more users for inspection, review, approval, or generally, viewing. Conversely, where the image includes another shadow segment, the computing device 102 returns, to step 508 for each of the additional shadow segments. When all of the shadow segments are mitigated from the image, the computing device 102 stores the shadow-mitigated image, at 526.

It should be appreciated that in at least one embodiment, the computing device 102 may mitigate multiple shadow segments at one time from an image, rather than mitigating each shadow segment individually as described above.

Based on the above, the shadow segments in the images are mitigated, whereby the images include a more complete view and/or clear view of the ground, including, for example, terrain, objects, etc., of the ground. The images are effectively transformed to look more visually appealing, and to yield greater detail, as an image product, which provides more visible enhancement of the ground underneath shadow segments of the original images.

In view of the above, the systems and methods herein provide for use of the image data included in the shadow segment to relight the shadow segment, rather than replace the shadow segment from other images. In connection therewith, the tonal histogram matching, which is specific to a shadow segment, is employed to relight an image including that shadow segment. The relighted image is then combined with a matte, generated by a model (e.g., trained on normalized difference values, etc.) to define a shadow-mitigated image for the original image. Thus, the systems and methods herein utilize techniques which deviate from conventional techniques. In doing so, the quality of the image with the shadow segment being mitigated is enhanced.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure may transform a general-purpose computing device into a special-purpose computing device when configured to perform one or more of the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing, by a computing device, an original image of a geospatial location, the original image including a shadow segment; (b) generating, by the computing device, using a model architecture, a matte for the original image, based on the image and a shadow mask for the image, the model architecture including a U-Net model; (c) generating, by the computing device, a first histogram of tones of shadow pixels of said shadow segment included in the original image; (d) generating, by the computing device, a second histogram of tones of an adjacent region of the original image, which is proximate to the shadow segment, yet outside a boundary of the shadow segment; (e) defining, by the computing device, a lookup table based on histogram matching between the first histogram and the second histogram; (f) relighting, by the computing device, the original image based on the lookup table; (g) based on the shadow mask and the matte, generating a shadow-mitigated image from the relighted image of the original image, whereby the shadow segment in the original image is mitigated; and/or (h) storing the shadow-mitigated image in a memory.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in mitigating shadow segments from images, the method comprising:
accessing, by a computing device, an original image of a geospatial location, the original image including a first shadow segment;
generating, by the computing device, using a model architecture, a matte for the original image, based on the image and a shadow mask for the image, the model architecture including a U-Net model;
(a) generating, by the computing device, a first histogram of tones of shadow pixels of said first shadow segment included in the original image;
(b) generating, by the computing device, a second histogram of tones of an adjacent region of the original image, which is proximate to the first shadow segment, yet outside a boundary of the first shadow segment;
(c) defining, by the computing device, a lookup table based on histogram matching between the first histogram and the second histogram;
(d) relighting, by the computing device, the original image based on the lookup table;
(e) based on the shadow mask and the matte, generating a shadow-mitigated image from the relighted image of the original image, whereby the first shadow segment in the original image is mitigated; and
storing the shadow-mitigated image in a memory.

2. The computer-implemented method of claim 1, wherein the first shadow segment included in the original image is a cloud shadow segment; and
wherein the original image includes a top-down view of a location.

3. The computer-implemented method of claim 1, wherein the original image further includes a second shadow segment; and
further comprising:
identifying the first shadow segment and the second shadow segment in the original image; and
repeating steps (a)-(e) for the second shadow segment in the original image.

4. The computer-implemented method of claim 1, wherein the model architecture includes a U-Net model.

5. The computer-implemented method of claim 4, wherein generating the matte includes generating the matte further based on a gain and bias from a ResNeXt regressor model of the model architecture.

6. The computer-implemented method of claim 1, further comprising:
accessing a training set, which includes training shadow-free images, corresponding training shadow-added images, which correspond to the training shadow-free images, and corresponding training shadow masks for shadow segments(s) in the training shadow-added images; and
training, by the computing device, the model architecture based on the training set.

7. The computer-implemented method of claim 6, further comprising generating synthetic shadow segments for each shadow-free image based on a gain and a bias, to define the training shadow-added images.

8. The computer-implemented method of claim 7, wherein training the model architecture is further based on the gain and the bias.

9. The computer-implemented method of claim 1, wherein generating the first histogram includes counting pixel intensities for each of multiple tonal ranges.

10. A non-transitory computer-readable storage medium comprising executable instructions for use in mitigating shadow segments from images, which when executed by at least one processor, cause the at least one processor to:
access an original image of a geospatial location, the original image including a first shadow segment;
generate, using a model architecture, a matte for the original image, based on the image and a shadow mask for the image, the model architecture including a U-Net model;
(a) generate a first histogram of tones of shadow pixels of said first shadow segment included in the original image;
(b) generate a second histogram of tones of an adjacent region of the original image, which is proximate to the first shadow segment, yet outside of a boundary of the first shadow segment;
(c) define a lookup table based on histogram matching between the first histogram and the second histogram;
(d) relight the original image based on the lookup table;
(e) based on the shadow mask and the matte, generate a shadow-mitigated image from the relighted image of the original image, whereby the first shadow segment in the original image is mitigated; and
store the shadow-mitigated image in a memory.

11. The non-transitory computer-readable storage medium of claim 10, wherein the first shadow segment included in the original image is a cloud shadow segment; and
wherein the original image includes a top-down view of a location.

12. The non-transitory computer-readable storage medium of claim 10, wherein the original image includes at least one additional shadow segment; and
wherein the executable instructions, when executed by at least one processor, cause the at least one processor to:
identify the first shadow segment and the at least one additional shadow segment; and
repeat steps (a)-(e) for each of the at least one additional shadow segments in the original image.

13. The non-transitory computer-readable storage medium of claim 10, wherein the model architecture includes a U-Net model.

14. The non-transitory computer-readable storage medium of claim 13, wherein generating the matte includes generating the matte further based on a gain and bias from a ResNeXt regressor model of the model architecture.

15. The non-transitory computer-readable storage medium of claim 10, wherein the executable instructions, when executed by the at least one processor, cause the at least one processor to:
access a training set, which includes training shadow-free images, corresponding training shadow-added images, which correspond to the training shadow-free images, and corresponding training shadow masks for shadow segment(s) in the training shadow-added images; and
train the model architecture based on the training set.

16. The non-transitory computer-readable storage medium of claim 15, wherein the executable instructions, when executed by the at least one processor, cause the at least one processor to generate synthetic shadow segments for each shadow-free image based on a gain and a bias, to define the training shadow-added images.

17. The non-transitory computer-readable storage medium of claim 16, wherein the executable instructions, when executed by the at least one processor, cause the at least one processor to train the model architecture further based on the gain and the bias.

18. The non-transitory computer-readable storage medium of claim 10, wherein the executable instructions, when executed by the at least one processor, cause the at least one processor, in generating the first histogram, to count pixel intensities for each of multiple tonal ranges.

19. A system for use in mitigating shadow segments from images, the system comprising:
a computing device including a non-transitory storage memory and a processor coupled to the non-transitory storage memory, the memory including an original image of a geospatial location, the original image including a first shadow segment; and
wherein the processor is configured, by executable instructions, to:
access the original image;
generate, using a model architecture having a SP-Net and an M-Net, a matte for the original image, based on the image and a shadow mask for the image;
identify the first shadow segment in the original image; and
for first identified shadow segment in the image:
(a) generate a first histogram of tones of shadow pixels of said first shadow segment included in the original image;
(b) generate a second histogram of tones of an adjacent region of the original image, which is proximate to the first shadow segment, yet outside of a boundary of the first shadow segment;
(c) define a lookup table based on histogram matching between the first histogram and the second histogram;
(d) relight the original image based on the lookup table; and
(e) based on the shadow mask and the matte, generate a shadow-mitigated image from the relighted image of the original image, whereby the first shadow segment in the original image is mitigated; and
store the shadow-mitigated image in the non-transitory storage memory.
